(19) United States
(12) Patent Application Publication
(10) Pub. No.: US 2014/0035507 A1
(43) Pub. Date: Feb. 6, 2014

(54) MOTOR DECELERATION METHOD AND MOTOR DRIVING APPARATUS APPLYING THE MOTOR DECELERATION METHOD

(71) Applicant: DELTA ELECTRONICS, INC., Taoyuan Hsien (TW)

(72) Inventors: Chien-Yu CHI, Taoyuan Hsien (TW); Chen-Hsiang KUO, Taoyuan Hsien (TW); Sheng-Chieh CHANG, Taoyuan Hsien (TW); Ting-Chung HSIEH, Taoyuan Hsien (TW); Shih-Chieh LIAO, Taoyuan Hsien (TW)

(73) Assignee: DELTA ELECTRONICS, INC., Taoyuan Hsien (TW)

(21) Appl. No.: 13/750,324

(22) Filed: Jan. 25, 2013

(30) Foreign Application Priority Data
Jul. 31, 2012 (TW) 101127553

(51) Int. Cl. H02P 3/18

(52) U.S. Cl. CPC H02P 3/18
USPC 318/807

(57) ABSTRACT

The present invention discloses a motor deceleration method which is applied to a motor driving apparatus. The motor driving apparatus includes an energy-storing unit and a controlling unit, and outputs a driving signal to control the motor. The controlling unit controls a driving frequency of the driving signal. The driving deceleration method includes following steps of controlling the driving frequency to zero; increasing the driving frequency in a linear way by using the controlling unit; detecting whether a terminal voltage difference of the energy-storing unit is increased to a preset voltage value, and if yes, adjusting the driving signal to keep the terminal voltage difference at the preset voltage value; and reducing the driving frequency continuously to decelerate the motor.

### CROSS REFERENCE TO RELATED APPLICATIONS

This Non-provisional application claims priority under 35 U.S.C. §119(a) on Patent Application No(s). 101127553 filed in Taiwan, Republic of China on Jul. 31, 2012, the entire contents of which are hereby incorporated by reference.

### BACKGROUND OF THE INVENTION

1. Field of Invention

The invention relates to a motor deceleration method and a motor driving apparatus applying the same that controls a driving frequency input to the motor for decelerating the motor.

2. Related Art

FIG. 1 is a schematic driving diagram of a conventional three-phase alternating current (AC) induction motor. The driving system of the three-phase AC induction motor includes a three-phase AC power, a motor driver 1 and a three-phase induction motor. The motor driver 1 can use the pulse width modulation (PWM) technology to change the amplitude and frequency of the driving signal output from its converter for controlling the speed of the motor. When the frequency of the driving signal is increased, the motor can be accelerated, and when the frequency of the driving signal is decreased, the motor can be decelerated,

Besides, for assisting the energy transformation during the deceleration period, a braking device 11 as shown in FIG. 1 in the conventional art is used to counteract the feedback kinetic energy during the motor's deceleration. The braking device 11 can be a braking resistor or a braking energy regenerator. The braking resistor can transform the feedback kinetic energy during the motor's deceleration into the thermal energy so as to deplete it. The braking energy regenerator can transform the feedback kinetic energy during the motor's deceleration into the three-phase current that flows back to the power source again.

However, the braking resistor will increase the cost, and besides, may induce some dangerous cases under some kind of environment. For example, in the environment of a large number of inflammable materials, a fire accident will occur due to the excessive heat generated by the braking resistor. On the other hand, if the braking energy regenerator is used, the cost will be increased a lot. Besides, in the situation of an immediate need to stop the motor for an emergency, if the feedback kinetic energy during the motor's deceleration is not completely transformed or depleted, the motor driver 1 will be crashed easily because a protection mechanism is triggered. In this case, the motor will be even damaged.

Besides, in the conventional art, a stage-type control to decrease the frequency for decelerating the motor is also proposed, which can immediately stop the motor without externally connecting any braking device. However, this method is dependent on the structure and standard of the motor. In other words, the optimum operating frequency is varied with the different structure of the motor or circuit deposition of the whole system. Therefore, the decrement of the frequency in the stage-type method is not easy to be determined. Besides, if the frequency decrement is set wrongly, the deceleration effect will be reduced a lot.

Therefore, it is an important subject to provide a motor deceleration method and a motor driving apparatus that can immediately stop the motor without externally connecting any braking device.

### SUMMARY OF THE INVENTION

In view of the foregoing subject, an objective of the invention is to provide a motor deceleration method and a motor driving apparatus using the same that can immediately stop the motor without externally connecting any braking device.

To achieve the above objective, a motor deceleration method of the invention is cooperated with a motor driving apparatus. The motor driving apparatus comprises an energy-storing unit and a controlling unit, and outputs a driving signal to control a motor. The controlling unit controls a driving frequency of the driving signal. The motor deceleration method comprises steps of: controlling the driving frequency to zero; increasing the driving frequency in a linear way by using the controlling unit; detecting whether a terminal voltage difference of the energy-storing unit is increased to a preset voltage value, and if yes, adjusting the driving signal to keep the terminal voltage difference at the preset voltage value, and if no, decreasing the driving frequency and adjusting the driving signal to keep the terminal voltage difference at a present voltage value when the driving frequency is increased to a preset frequency value; and reducing the driving frequency continuously to decelerate the motor. The driving frequency is zero because the driving signal is temporarily not output. The controlling unit controls the driving frequency that is increased from zero or a preset value in a linear way.

In one embodiment, the controlling unit decreases the driving frequency and decelerates the motor to a stationary state. The energy-storing unit can be a capacitor. When the motor is stopped or the driving frequency is decreased to zero, the terminal voltage difference of the energy-storing unit is decreased by the consumption of the circuit of the motor driving apparatus so that the terminal voltage difference is decreased to the state as before being increased.

To achieve the above objective, a motor driving apparatus of the invention for driving a motor comprises an energy-storing unit, a current-converting unit and a controlling unit. The current-converting unit is electrically connected with the energy-storing unit and outputs a driving signal to drive the motor. The controlling unit is electrically connected with the current-converting unit and detects the driving signal and a terminal voltage difference of the energy-storing unit. The controlling unit controls the current-converting unit to make a driving frequency of the driving signal become zero, and then controls the driving frequency that is increased in a linear way. When the terminal voltage difference is increased to a preset voltage value, the controlling unit adjusts the driving frequency of the driving signal to keep the terminal voltage difference at the preset voltage value, and the controlling unit reduces the driving frequency continuously to decelerate the motor. The controlling unit controls the driving frequency that is increased from zero or a preset value in a linear way. When the terminal voltage difference is not increased to the preset voltage value and the driving frequency is increased to a preset frequency value, the controlling unit begins to de decrease the driving frequency and adjusts the driving signal to keep the terminal voltage difference at a present voltage value. The controlling unit decreases the driving frequency and decelerates the motor to a stationary state.

In one embodiment, the driving frequency is zero because the driving signal is temporarily not output. The energy-storing unit can be a capacitor. When the motor is stopped or the driving frequency is decreased to zero, the terminal voltage difference of the energy-storing unit is decreased by the consumption of the circuit of the motor driving apparatus so that the terminal voltage difference is decreased to the state as before being increased.

In one embodiment, the motor driving apparatus can further include a current-rectifying unit electrically connected with the energy-storing unit. The current-rectifying unit can covert an alternating current signal into a direct current signal that is then input to the energy-storing unit.

As mentioned above, a motor deceleration method cooperated with a motor driving apparatus includes the following steps of: controlling the driving frequency to zero; increasing the driving frequency in a linear way by using the controlling unit; detecting whether a terminal voltage difference of the energy-storing unit is increased to a preset voltage value, and if yes, adjusting the driving signal to keep the terminal voltage difference at the preset voltage value; and reducing the driving frequency continuously to decelerate the motor. Accordingly, the kinetic energy flowing back form the motor M can be consumed by the inner circuit of the motor driving apparatus or be temporarily stored in the energy-storing unit without externally connecting any braking device, for rapidly decelerating and stopping the motor.

Besides, the motor deceleration method and the motor driving apparatus of the invention can not be affected by the rated capacity of the motor so that the same controlling method can be applied to different motors to decelerate them. In addition, the motor deceleration method of the invention doesn't use the stage-type non-continuous commands to control the driving frequency for the deceleration. Therefore, the motor or the whole system in the invention will not vibrate during the rapid deceleration.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic driving diagram of a conventional three-phase alternating current (AC) induction motor;

FIG. 2A is a block diagram of a system including a motor driving apparatus of a preferred embodiment of the invention;

FIG. 2B is a flow chart of a motor deceleration method of a preferred embodiment of the invention;

FIGS. 3A to 3C are schematic diagrams of different motor deceleration mechanisms applied to the motor driving apparatus of the invention; and

FIG. 4 is a schematic diagram showing the torque versus the slip of the motor during the period that the motor driving apparatus controls the deceleration of the motor according to a preferred embodiment of the invention.

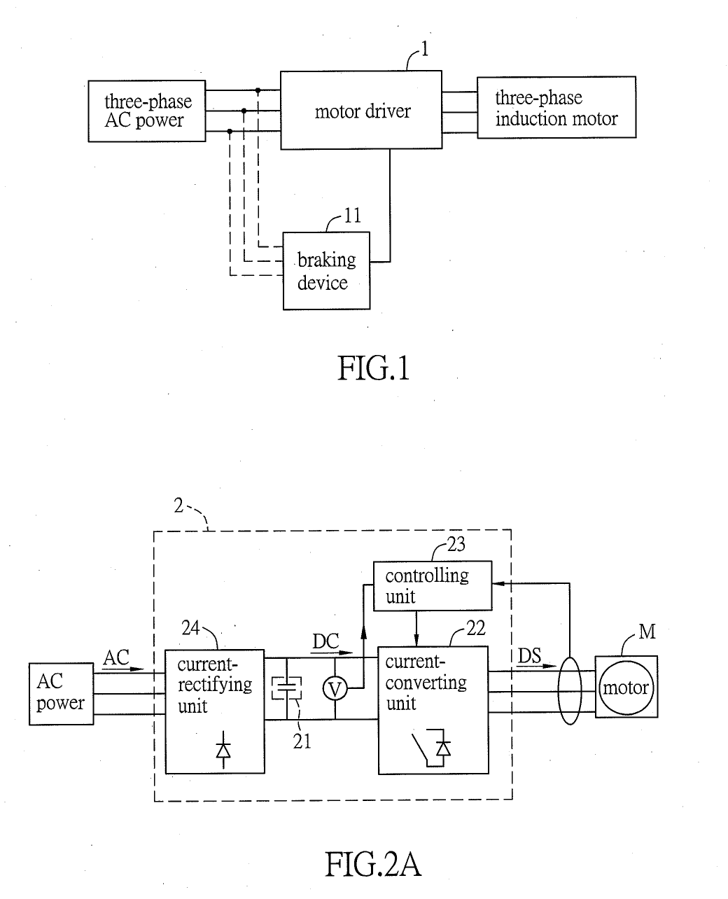

### DETAILED DESCRIPTION OF THE INVENTION

The present invention will be apparent from the following detailed description, which proceeds with reference to the accompanying drawings, wherein the same references relate to the same elements.

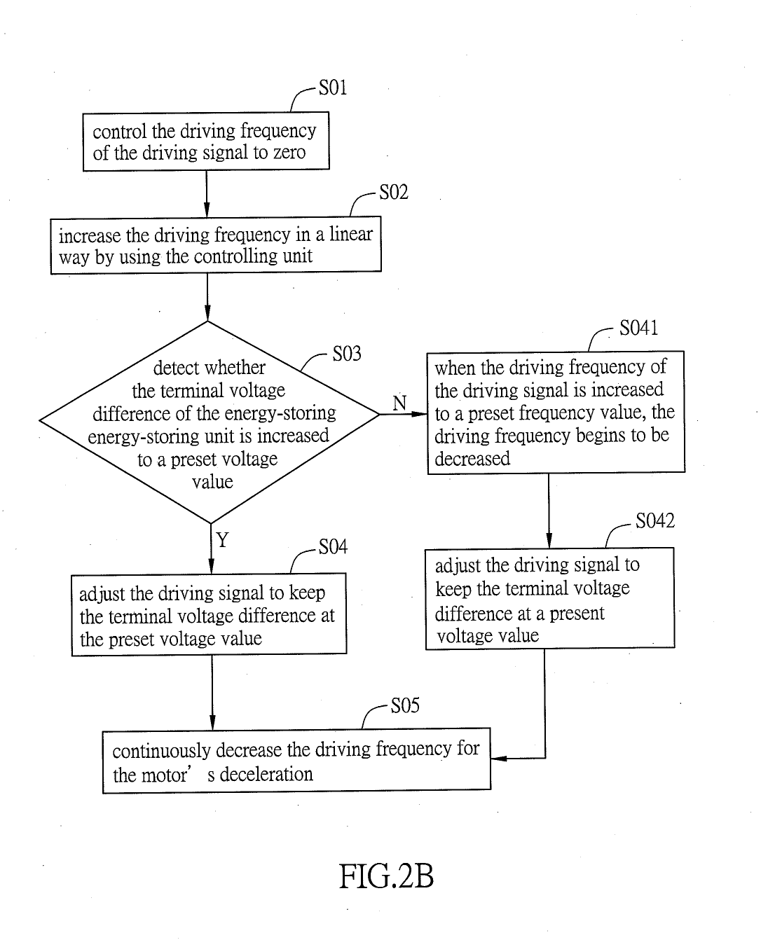

FIG. 2A is a block diagram of a system including a motor driving apparatus 2 of a preferred embodiment of the invention.

As shown in FIG. 2A, the motor driving apparatus 2 can receive an alternating current (AC) power and output a driving signal DS to control a motor M to rotate. Besides, the motor deceleration method is cooperated with the motor driving apparatus 2 for decelerating the motor so as to stop the motor. In the embodiment, the motor M is a three-phase induction motor, and the AC power can be a three-phase AC voltage source, such as city power.

The motor driving apparatus 2 includes an energy-storing unit 21, a current-converting unit 22, a controlling unit 23, and a current-rectifying unit 24.

The energy-storing unit 21 is a capacitor in the embodiment. The current-converting unit 22 is electrically connected with the energy-storing unit 21, and can output the driving signal DS to drive the motor M to rotate. Herein, the current-converting unit 22 is a DC/AC converter, and can receive a terminal voltage difference of the two ends of the energy-storing unit 21 for outputting the AC driving signal DS to drive the motor M. The current-converting unit 22 can be composed of at least an Insulate-Gate Bipolar Transistor (IGBT) or other power transistors.

The controlling unit 23 is electrically connected with the current-converting unit 22, and can detect the driving signal DS and the terminal voltage difference of the energy-storing unit 21. As shown in FIG. 2A, in this embodiment, a voltmeter V is connected to the two ends of the energy-storing unit 21 to detect its terminal voltage difference, and then the detected signal is input to the controlling unit 23 so that the controlling unit 23 can control the current-converting unit 22 and thus control the driving frequency and amplitude of the driving signal DS. The controlling unit 23 can be made by hardware, software, firmware, or their combinations, and can use the PWM technology to control a plurality of transistors of the current-converting unit 22 to switch on and off, thereby controlling the driving frequency and amplitude of the driving signal DS.

The current-rectifying unit 24 is electrically connected with the energy-storing unit 21, and can rectify an alternating current signal AC output from the AC power into a direct current signal DC that is then input to the energy-storing unit 21. Before the current-converting unit 22 operates, the energy-storing unit 21 stores the energy from the AC power to a full state with a stable voltage difference. In the embodiment, the current-rectifying unit 24 is an AC/DC converter, and can rectify an alternating current signal AC output from the AC power into a direct current signal DC that is then input to the energy-storing unit 21. The current-rectifying unit 24 is a bridge rectifier for example.

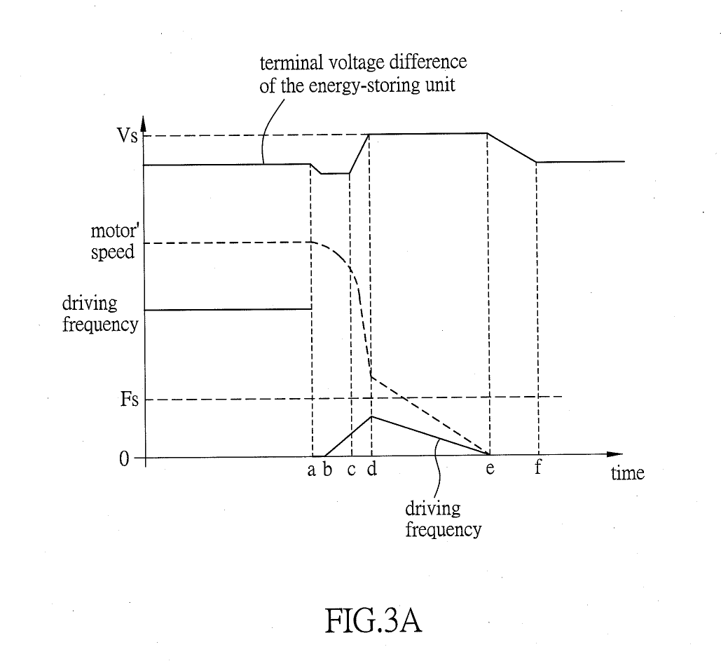

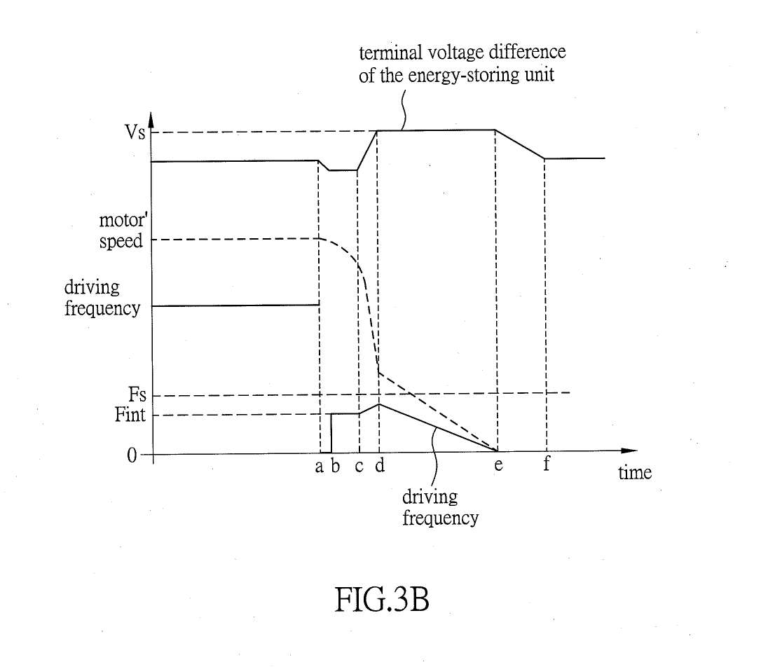

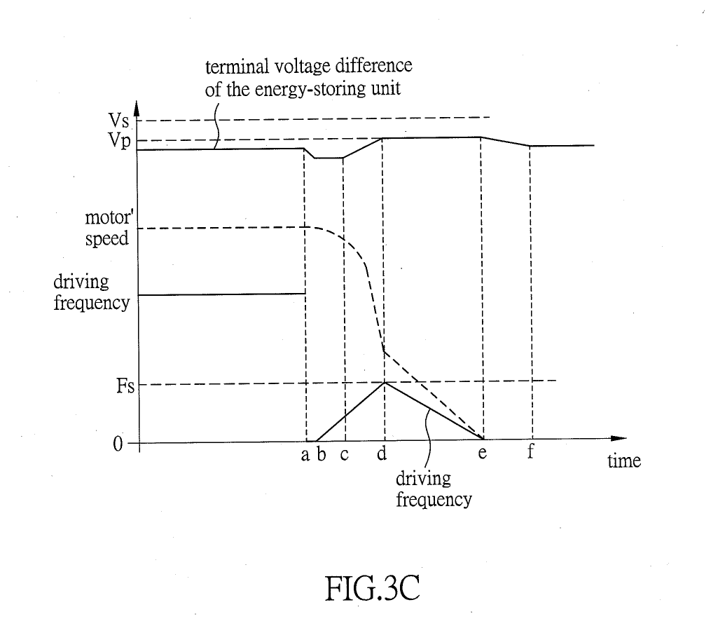

FIG. 2B is a flow chart of a motor deceleration method of a preferred embodiment of the invention, and FIG. 3A is a schematic diagram of the motor deceleration mechanism applied to the motor driving apparatus 2.

Referring to FIGS. 2B and 3A, when the motor driving apparatus 2 receives a command (a deceleration command from a digital operator (not shown), for example, electrically connected to the controlling unit 23) at the time a, the deceleration method of the motor M can include the following steps S01 to S05, S041 and S042.

The step S01 is to control the driving frequency of the driving signal DS to zero. Herein, when the rapid deceleration command is delivered (at the time a), the controlling unit 23 controls the current-converting unit 22 to temporarily stop outputting the driving signal DS (i.e. temporarily cease the output of the motor driving apparatus 2 so that the driving signal DS can not be output) so that the driving frequency can be immediately lowered down to zero. In the meantime, the terminal voltage difference of the energy-storing unit 21 is also lowered down. If the output of the motor driving apparatus 2 is not stopped to eliminate the magnetic excitation of the motor M, the terminal voltage difference of the energy-storing unit 21 will be raised at the initial starting moment of the deceleration. Therefore, the temporary stop action mentioned above is conducted for stopping inputting the current to the motor M to prevent the magnetic excitation of the motor M.

The step S02 is to increase the driving frequency in a linear way by using the controlling unit 23. Herein as shown in FIG. 3A, a speed monitoring function is started at the time b. The interval between the time b and the time a can be adjusted according to the characteristics of the motor M, and can be preset by the user or determined by a controlling program of the motor. By the interval, the terminal voltage difference of the energy-storing unit 21 can be prevented from being raised and then lowered down. In the embodiment, the speed monitoring function is started at the time b while the controlling unit 23 controls the driving frequency of the driving signal DS output by the current-converting unit 22 so as to increase the driving frequency from zero in a linear way. After the time c, the terminal voltage difference of the energy-storing unit 21 is obviously raised high with the increasing driving signal, and that is, the braking kinetic energy of the motor M begins to flow back to the motor driving apparatus 2 so that the terminal voltage difference of the energy-storing unit 21 is increased.

FIG. 3B is a schematic diagram of a motor deceleration mechanism of another preferred embodiment of the invention.

In this embodiment, before delivering the deceleration command (the time a), during a closed-loop control of the motor, the instant speed of the motor M, and the operating point (of the zero torque) under the situation of no energy flowing back (i.e. the entire energy is consumed by the motor's circuit) are computed by estimating the motor's parameters, and the voltage/current information that is instantly measured.

Accordingly, in this embodiment, the motor's parameters and the system's parameters can be estimated in advance during the closed-loop control of the motor by the software, hardware, firmware or their combinations to determine a preset value Fint of the driving frequency. The motor's parameters and the system's parameters can include the circuit parameters (such as resistance, leakage inductance, or mutual inductance) of the motor's stator and rotor, the iron loss, copper loss or friction loss of the motor, the current or magnetic filed of the motor's stator and rotor, and estimated speed value of the motor's rotor. The above parameters can be put in the equations in which the torque of the motor is equivalent to zero to calculate the slip value of the operating point. The preset value Fint of the driving frequency can be obtained by using the slip value with the estimated speed value through the inverse calculation.

Besides, during the period of executing the speed monitoring function (from the time b to the time d as shown in FIG. 3B), the user can determine the driving frequency that is increased or kept levelly according to the requirements. Herein as shown in FIG. 3B, at the time b, the controlling unit 23 controls the driving frequency at the preset value Fint, and then controls the driving frequency, at the time c, to be increased in a linear way from the preset value Fint just as the above-mentioned step S02. In the meantime, the terminal voltage difference of the energy-storing unit 21 is also raised with the increasing driving frequency. In this embodiment, if the preset value Fint is accurately corresponding to the largest consumption point of the motor M, the deceleration time needed for the motor M can be reduced.

Referring to FIG. 3A again, at the time c, the terminal voltage difference of the energy-storing unit 21 begins to be raised due to the flowing-back energy caused by the motor's deceleration. Besides the motor's own loss, the raising of the terminal voltage difference of the energy-storing unit 21 represents that negative torque is caused in the motor M and a portion of the rotational kinetic energy of the motor M flows back to the motor driving apparatus 2 in the form of electric energy. The electric energy flowing back can be consumed by the circuit of the motor driving apparatus 2 and stored in the energy-storing unit 21 at the same time. Therefore, during the period between the time c and the time d, the motor's deceleration is more effectively (shown by the sharply descending curve of the motor's speed).

The step S03 is to detect whether the terminal voltage difference of the energy-storing unit 21 is increased to a preset voltage value Vs, and if yes, to execute the step S04 adjusting the driving signal DS to keep the terminal voltage difference at the preset voltage value Vs, and if no, to execute the steps S041 and S042.

As shown in FIG. 3A, when the electric energy flowing back during the deceleration of the motor M is continuously stored in the energy-storing unit 21 so that the terminal voltage difference of the energy-storing unit 21 is increased to the preset voltage value Vs (at the time d), the controlling unit 23 controls and adjusts the driving frequency of the driving signal DS so that the terminal voltage difference of the energy-storing unit 21 is maintained at the preset voltage value Vs. The preset voltage value Vs is called “smart stall voltage level”. In other words, based on the preset voltage value Vs as a control basis, the motor driving apparatus 2 executes the smart stall. The smart stall can keep the terminal voltage difference of the energy-storing unit 21 so that the motor driving apparatus 2 will not execute the protection mechanism that stops the output of the driving apparatus. Thereby, the motor driving apparatus 2 can maintain the control to continuously execute the deceleration command.

In the step S03, if the kinetic energy flowing back from the motor M is not sufficient to raise the terminal voltage difference of the energy-storing unit 21 to the preset voltage value Vs (this situation also represents the kinetic energy to be dealt with during the motor's deceleration is less, or the capacitance of the energy-storing unit 21 is larger), the steps S041 and S042 will be executed. As shown in FIG. 3C, when the driving frequency of the driving signal DS is increased to a preset frequency value Fs, the controlling unit 23 controls and decreases the driving frequency of the driving signal DS so as to keep the terminal voltage difference of the energy-storing unit 21 at a present voltage value Vp while the smart stall also begins. The preset frequency value Fs can be called “smart stall frequency level”. In other words, form the time d, the controlling unit 23 decreases the driving frequency of the driving signal DS in a linear way and thus the speed of the motor M is decreased continuously. The above-mentioned present voltage value Vp means the voltage value of the energy-storing unit 21 when the driving frequency is raised to the preset frequency value Fs.

Then the step S05 is executed to continuously decrease the driving frequency for the motor's deceleration. As shown in FIGS. 3A to 3C, from the time d, the controlling unit 23 decreases the driving frequency of the driving signal DS continuously in a linear way until the speed of the motor M is decreased to zero (at the time e).

After the motor M stops rotating at the time e or the driving frequency is decreased to zero, the electric energy stored in the energy-storing unit 21 will be consumed by the inner resistance of the inner components of the motor driving apparatus 2 so that the terminal voltage difference of the energy-storing unit 21 is lowered down, and thus the original direct current level can be achieved again at the time f, indicating that the system goes back to the normal state. At the time e, the motor M is rapidly decelerated to a stationary state. Thereby, the electric energy stored in the energy-storing unit 21 is released and consumed by the inner components of the motor driving apparatus 2, so the voltage of the energy-storing unit 21 is lowered down. To be noted, the interval between the time e and the time f can be determined by the circuit of the motor driving apparatus 2.

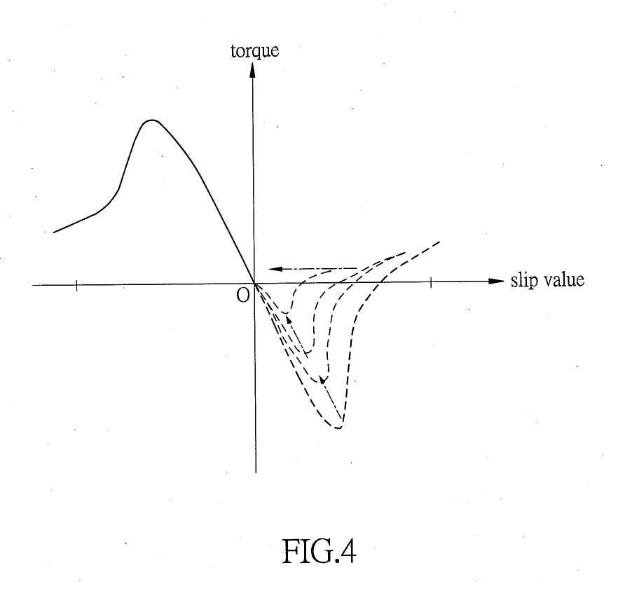

FIG. 4 is a schematic diagram showing the torque versus the slip of the motor M during the period that the motor driving apparatus 2 controls the deceleration of the motor M according to a preferred embodiment of the invention. In FIG. 4, different motor's speeds are corresponding to different torque curves, and when the motor's speed is slower, the corresponding torque curve approaches the origin closer.

The motor deceleration method of the invention can be operated in the negative slip area (the right half plane of FIG. 4) of the motor M. As shown in FIGS. 3A and 4, after the motor is decelerated at the time a, the slip value will be gradually raised from the negative infinity and then moves to the origin O rapidly with the increasing frequency, according to the definition. With the same motor's speed, once the slip value moves to the negative torque area, the rotational energy begins to flow back to the driving apparatus from the motor. In the meantime, just like the non-deceleration operation in which the energy-storing unit 21 stores the electric power from the AC power through the current-rectifying unit 24, the energy-storing unit 21 begins to store the energy flowing back from the motor M (at this moment the induction motor functions as an induction power generator). However, different from the situation that the energy-storing unit 21 stores the electric power from the AC power through the current-rectifying unit 24, the flowing-back electric energy converted from the rotational kinetic energy will continuously charge the energy-storing unit 21 so as to raise the terminal voltage difference of the energy-storing unit 21. Besides, the deceleration mechanism of the invention includes monitoring the terminal voltage difference of the energy-storing unit 21 until the terminal voltage difference is increased to the preset voltage value Vs (i.e. the smart stall voltage level), or fixing the operating point when the driving frequency is increased to the preset frequency value Fs (the smart stall frequency level). With the speed of the motor M gradually decreased, the curve corresponding to the torque and slip will gradually move towards the direction of the origin O (such as the direction indicated by the dotted arrow line). Besides, with the movement of the curve corresponding to the torque and slip, the driving frequency of the motor M will be decreased until the motor M is stopped in order to fix the operating point so that the terminal voltage difference of the energy-storing unit 21 can be kept at the smart stall voltage level.

By verification, in the invention, the kinetic energy flowing back form the motor M can be consumed by the inner circuit of the motor driving apparatus 2 or be temporarily stored in the energy-storing unit 21 at a open-loop operation mode (i.e. voltage/frequency control mode) without externally connecting any braking device, for rapidly decelerating and stopping the motor. Besides, compared with the conventional art, the motor deceleration method and the motor driving apparatus 2 of the invention can not be affected by the rated capacity of the motor M so that the same controlling method can be applied to different motors with different rated capacities to decelerate them. In addition, the motor deceleration method of the invention doesn't use the stage-type non-continuous commands to control the driving frequency for the deceleration. Therefore, the motor M or the whole system in the invention will not vibrate during the rapid deceleration.

In summary, a motor deceleration method cooperated with a motor driving apparatus includes the following steps of: controlling the driving frequency to zero; increasing the driving frequency in a linear way by using the controlling unit; detecting whether a terminal voltage difference of the energy-storing unit is increased to a preset voltage value, and if yes, adjusting the driving signal to keep the terminal voltage difference at the preset voltage value; and reducing the driving frequency continuously to decelerate the motor. Accordingly, the kinetic energy flowing back form the motor M can be consumed by the inner circuit of the motor driving apparatus or be temporarily stored in the energy-storing unit without externally connecting any braking device, for rapidly decelerating and stopping the motor.

Besides, the motor deceleration method and the motor driving apparatus of the invention can not be affected by the rated capacity of the motor so that the same controlling method can be applied to different motors to decelerate them. In addition, the motor deceleration method of the invention doesn't use the stage-type non-continuous commands to control the driving frequency for the deceleration. Therefore, the motor or the whole system in the invention will not vibrate during the rapid deceleration.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A motor deceleration method cooperated with a motor driving apparatus comprising an energy-storing unit and a controlling unit and outputting a driving signal to control a motor, wherein the controlling unit controls a driving frequency of the driving signal, the motor deceleration method comprising steps of:
(A) controlling the driving frequency to zero;
(B) increasing the driving frequency in a linear way by using the controlling unit;
(C) detecting whether a terminal voltage difference of the energy-storing unit is increased to a preset voltage value, and if yes, adjusting the driving signal to keep the terminal voltage difference at the preset voltage value; and
(D) reducing the driving frequency continuously to decelerate the motor.

2. The motor deceleration method as recited in claim 1, wherein in the step (B), the driving frequency is increased from zero or a preset value in a linear way.

3. The motor deceleration method as recited in claim 1, wherein in the step (C), if no, when the driving frequency is increased to a preset frequency value, decreasing the driving frequency and adjusting the driving signal to keep the terminal voltage difference at a present voltage value.

4. The motor deceleration method as recited in claim 1, wherein the controlling unit decreases the driving frequency and decelerates the motor to a stationary state.

5. The motor deceleration method as recited in claim 1, wherein when the motor is stopped or the driving frequency is decreased to zero, the terminal voltage difference of the energy-storing unit is decreased by the circuit of the motor driving apparatus.

6. The motor deceleration method as recited in claim 1, wherein the energy-storing unit is a capacitor.

7. The motor deceleration method as recited in claim 1, wherein in the step (A), the driving frequency is zero because the driving signal is temporarily not output.

8. A motor driving apparatus for driving a motor, comprising:
an energy-storing unit;
a current-converting unit electrically connected with the energy-storing unit and outputting a driving signal to drive the motor; and
a controlling unit electrically connected with the current-converting unit and detecting the driving signal and a terminal voltage difference of the energy-storing unit,
wherein the controlling unit controls the current-converting unit to make a driving frequency of the driving signal become zero, and then controls the driving frequency that is increased in a linear way, when the terminal voltage difference is increased to a preset voltage value, the controlling unit adjusts the driving frequency of the driving signal to keep the terminal voltage difference at the preset voltage value, and the controlling unit reduces the driving frequency continuously to decelerate the motor.

9. The motor driving apparatus as recited in claim 8, wherein the controlling unit controls the driving frequency that is increased from zero or a preset value in a linear way.

10. The motor driving apparatus as recited in claim 8, wherein when the terminal voltage difference is not increased to the preset voltage value and the driving frequency is increased to a preset frequency value, the controlling unit begins to de decrease the driving frequency and adjusts the driving signal to keep the terminal voltage difference at a present voltage value.

11. The motor driving apparatus as recited in claim 8, wherein the controlling unit decreases the driving frequency and decelerates the motor to a stationary state.

12. The motor driving apparatus as recited in claim 8, wherein when the motor is stopped or the driving frequency is decreased to zero, the terminal voltage difference of the energy-storing unit is decreased by the circuit of the motor driving apparatus.

13. The motor driving apparatus as recited in claim 8, wherein the driving frequency is zero because the driving signal is temporarily not output.
